(19) United States
(12) Patent Application Publication
(10) Pub. No.: US 2024/0392874 A1
(43) Pub. Date: Nov. 28, 2024

(54) AXLE ASSEMBLY WITH A FLUID RESERVOIR

(71) Applicant: Dana Automotive Systems Group, LLC, Maumee, OH (US)

(72) Inventors: Brian SITTERLY, Norwalk, OH (US); Thomas L. NAHRWOLD, Napoleon, OH (US)

(21) Appl. No.: 18/323,963

(22) Filed: May 25, 2023

(51) Int. Cl. F16H 57/04

(52) U.S. Cl. CPC F16H 57/045; F16H 57/0483

(57) ABSTRACT

Systems and methods for storing a working fluid in a fluid reservoir assembly. The fluid reservoir assembly includes, in one example, an axle tube circumferentially surrounding an axle shaft in a beam axle, a sleeve coupled to the axle tube, and a fluid reservoir containing a working fluid and formed in a cavity between an exterior surface of the axle tube and an interior surface of the sleeve. In the fluid reservoir assembly, the fluid reservoir is configured to fluidically connect to a component.

### TECHNICAL FIELD

The present disclosure relates to an axle with a fluid reservoir assembly which stores fluid in a location around an axle tube.

### BACKGROUND AND SUMMARY

Vehicles use oil reservoirs for storing reserves of oil for component lubrication as well as component actuation, in some instances. For example, oil stored in the reservoirs is used to actuate clutches in certain powertrains. In certain vehicles, the oil reservoir may be in the form of a dedicated oil tank with an oil pump that provides oil to desired components.

The inventors have recognized several drawbacks with previous fluid reservoirs. For instance, using dedicated oil tanks can decrease vehicle ground clearance due to the relatively low positon of the oil tank in the vehicle. Further, dedicated oil tanks may pose space constraints on surrounding vehicle components and systems.

The inventors have recognized the abovementioned challenges and developed a fluid reservoir assembly to at least partially overcome the challenges. The fluid reservoir assembly includes, in one example, an axle tube circumferentially surrounding an axle shaft in a beam axle and a sleeve coupled to the axle tube. The fluid reservoir assembly further includes a fluid reservoir containing a working fluid and formed in a cavity between an exterior surface of the axle tube and an interior surface of the sleeve. Further, in the fluid reservoir assembly, the fluid reservoir is configured to fluidically connect to a component. In this way, the fluid reservoir is compactly incorporated into the beam axle and imposes less space constraints on surrounding vehicle components and allows the vehicle's ground clearance to be increased, if desired.

In another example, the sleeve may be coupled to the axle tube via a threaded interface and the sleeve may include an end cap which is incorporated into an opposite side of the sleeve as the threaded interface. In such an example, the end cap may include a tool interface. In this way, the sleeve may be efficiently installed and removed from the axle tube.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows an example of a vehicle with an axle that includes a fluid reservoir assembly.

FIG. 2 shows a top view of an example of a fluid reservoir assembly in an axle.

FIG. 3 shows a side view of the fluid reservoir assembly, depicted in FIG. 2.

FIG. 4 shows a front view of the fluid reservoir assembly, depicted in FIG. 2.

FIG. 5 shows a side view of the fluid reservoir assembly, depicted in FIG. 2.

FIG. 6 shows a cross-sectional view of the fluid reservoir assembly, depicted in FIG. 2.

FIG. 7 shows a schematic depiction of a lubrication system for an axle assembly.

### DETAILED DESCRIPTION

A fluid delivery system which makes use of a fluid reservoir assembly that is incorporated into a vehicle axle is described herein. The fluid reservoir assembly is arranged around an axle tube and is formed via a sleeve which may be coupled (e.g., threaded) to an outside of the axle tube. In this way, the fluid reservoir is compactly incorporated into an axle which allows the ground clearance of the axle to be increased.

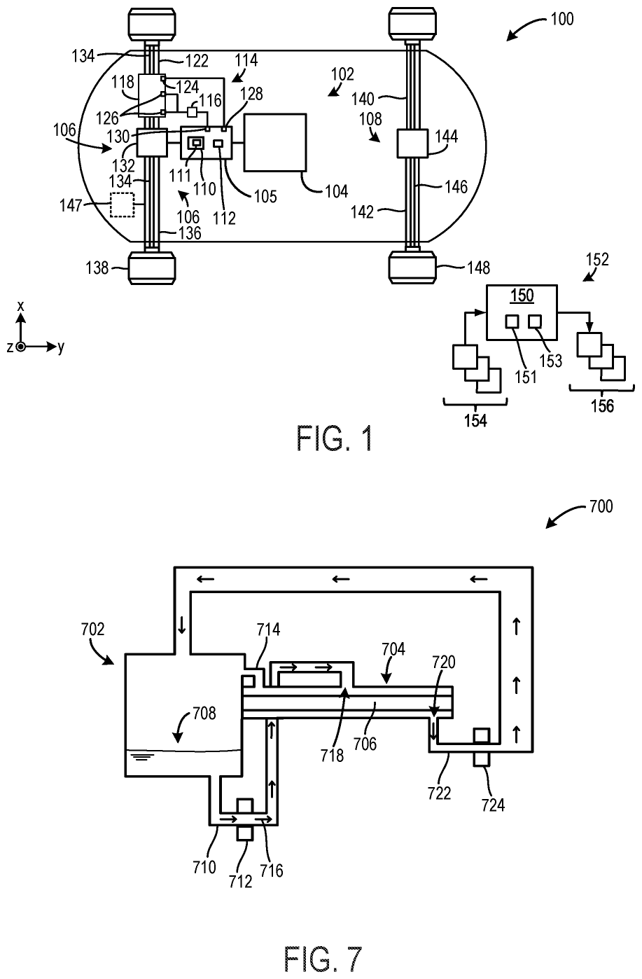

FIG. 1 shows a schematic illustration of a vehicle 100 with a powertrain 102. The powertrain 102 may include a prime mover 104 (e.g., a traction motor or an internal combustion engine), a gearbox 105 (e.g., a transmission), and a drive axle assembly 106. As such, the vehicle may be an electric vehicle (EV) such as an all-electric vehicle or a hybrid electric vehicle (HEV), in some examples, or an internal combustion engine vehicle, in other examples. In the HEV example, the engine may function to recharge an energy storage device (e.g., one or more traction batteries, capacitors, fuel cells, combinations thereof, and the like) which may be included in the powertrain or may provide mechanical power to another drive axle. However, in another example, the internal combustion engine may be used to provide propulsive power to the axle assembly 106 and/or another axle assembly 108.

In the EV example, the traction motor may be a motor-generator which therefore may be used to recharge the energy storage device during certain operating conditions, in one example. Further, in the EV example, the traction motor may be an alternating current (AC) motor (e.g., a multiphase motor) which may be more efficient than other types of motors. In such an example, an inverter is electrically coupled to the energy storage device and the traction motor. The inverter is configured to convert AC to direct current (DC) and vice versa. However, in other examples, a DC type traction motor may be used in the EV powertrain.

The gearbox 105 may include one or more clutches 110 with hydraulic actuators 111 and lubricated components 112. The clutches may be configured to shift between discrete gear ratios and/or disconnect the gearbox from upstream or downstream components. The lubricated components include components with lubricant demands such as bearings, shafts, gears, wet clutches, combinations thereof, and the like.

The vehicle 100 may further include a fluid delivery system 114 which may be used to deliver fluid to the lubricated components 112 and/or hydraulic actuators such as the hydraulic actuators 111. The fluid delivery system 114 may include a fluid pump 116 for delivering fluid to the lubricated components and/or hydraulic actuators. The fluid delivery system 114 may utilize a suitable working fluid such as oil (e.g., petroleum based oil, synthetic oil, and the like).

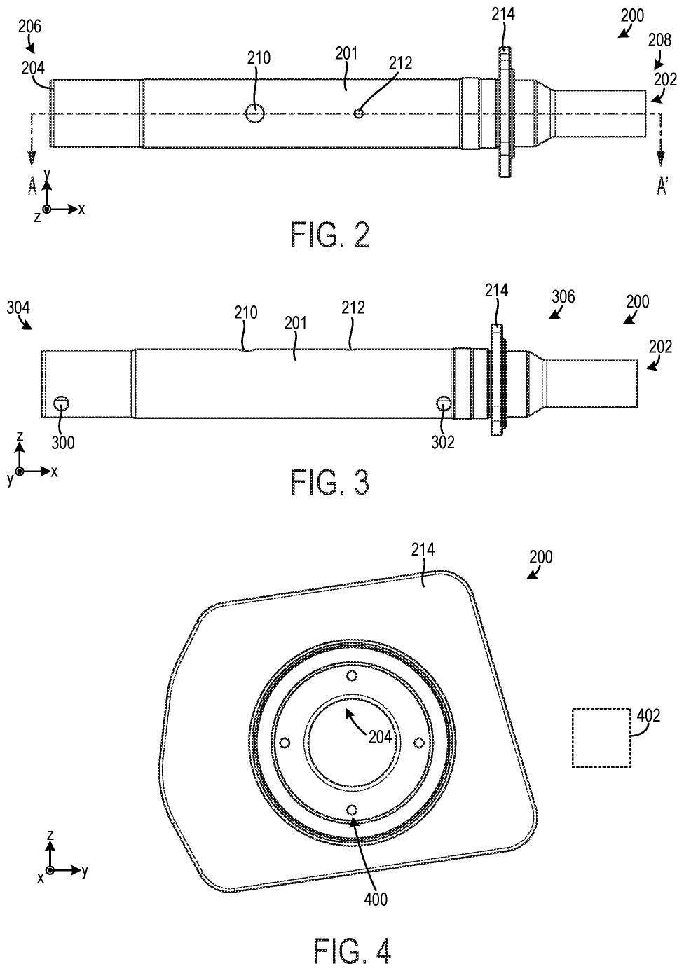

The fluid delivery system 114 includes a fluid reservoir assembly 118 that is incorporated into the axle assembly 106. To elaborate, the fluid reservoir assembly 118 is formed around an axle tube 122 in the axle assembly 106. The fluid reservoir assembly 118 includes a return port 124 and outlet ports 126. The outlet ports 126 are in fluidic communication with the pump 116 via fluid lines and the return port 124 is in fluidic communication with a fluid port 128 (e.g., an outlet port) in the gearbox 105 via a fluid line. Further, the pump 116 is in fluidic communication with another port 130 in the gearbox 105 via a fluid line. The ports described herein may specifically be fittings for hoses, lines, and the like. Further, the gearbox 105 may include conduits, passages, valves, nozzles, combinations thereof, and the like for routing fluid to the hydraulic actuators 111 and/or the lubricated components 112. The fluid reservoir assembly 118 has greater structural and functional complexity that is expanded upon herein with regard to FIGS. 2-6.

The axle assembly 106 may further include a differential 132 which is rotationally coupled to axle shafts 134 (e.g., half shafts). The differential 132 may be rotationally coupled to an upstream component such as the gearbox 105. Shafts, gears, chains, joints, combinations thereof may be used to provide this rotational connection. However, in other examples, the gearbox 105 may be directly coupled to the differential 132. For instance, in the EV embodiment, the axle assembly 106, the gearbox 105, and the electric motor may form an electric axle. The axle shafts 134 are at least partially circumferentially enclosed via axle tubes 122 and 136. The axle shafts 134 are rotationally coupled to drive wheels 138.

Additionally or alternatively, a fluid reservoir, similar to the fluid reservoir assembly 118, may be coupled to the axle tube 136. Even further, in additional or alternative examples, one or more fluid reservoirs, similar to the fluid reservoir assembly 118, may be incorporated into the axle assembly 108 (e.g., the non-drive axle assembly). To elaborate, a fluid reservoir may be coupled to one or both of the axle tubes 140 and 142. The axle assembly 106 may further include a differential 144 which is rotationally couple to axle shafts 146 which are in turn rotationally coupled to the wheels 148.

The fluid delivery system 114 may additionally include valves, hydraulic lines, hoses, filter(s), and the like which function to route the working fluid to target locations and component within the gearbox and/or other vehicle systems. Further, fluid delivery system may solely use the fluid reservoir assembly as a reservoir for fluid in the system. However, in alternate examples, the fluid delivery system may include additional fluid reservoirs. Further, the fluid reservoir assembly 118 may be included in a dry sump system.

FIG. 7 shows an example of a lubrication system 700 with may be a dry sump system. The lubrication system 700 provides a working fluid (e.g., oil) to an axle assembly 702 (e.g., an electric axle assembly). The lubrication system 700 includes a fluid reservoir assembly 704 that surrounds an axle tube 706 which at least partially encloses an axle shaft of the axle. The fluid reservoir assembly 704 is an example of the fluid reservoir assembly 118 depicted in FIG. 1. Further, at least a portion of the features of the exemplary fluid reservoir assembly described herein may be incorporated into the fluid reservoir assembly 704, shown in FIG. 7 and vice versa.

The axle assembly 702 includes a sump 708 (e.g., a dry sump). Fluid may be routed to the fluid reservoir assembly 704 from the sump 708 via a conduit 710 with a pump 712 (e.g., scavenger pump) coupled thereto. Further, a vent conduit 714 may extend between the axle assembly 702 and the fluid reservoir assembly 704. The vent conduit 714 vents air pressure as the oil in the reservoir cools. Additionally or alternatively, the pressure may be vented to the surrounding atmosphere. The vent conduit 714 allows gas to be vented from the fluid reservoir assembly 704. Arrows 716 indicate the general direction of fluid (e.g., oil) flow in the lubrication system 700.

The fluid reservoir assembly 704 may include a fluid inlet 718 fluidly coupled to the conduit 710. Further, the fluid reservoir assembly 704 may include a fluid outlet 720 fluidly coupled to the axle assembly 702 via a conduit 722 which provides cooled oil to lubrication points in the axle. A pump 724 (e.g., a pressure pump) may be coupled to the conduit 722.

Returning to FIG. 1, the axle assemblies 106 and/or 108 may be beam axle assemblies, in one example, which may be more durable and can carry higher loads than drive axles which are coupled to independent suspension systems. A beam axle is an axle with mechanical components which structurally support one another and extend between drive wheels. For instance, the beam axle may be a structurally continuous structure that spans the drive wheels on a lateral axis, in one embodiment. Thus, wheels coupled to the beam axle substantially move in unison when articulating, during, for example, vehicle travel on uneven surfaces. To elaborate, in the beam axle example, the camber angle of the wheels may remain substantially constant as the suspension moves through its travel. Therefore, the beam axle may be coupled to a dependent suspension system 147, in one example. However, in other examples, the electric axle may not be a beam axle and the axle may be coupled to an independent suspension system.

A controller 150 may form a portion of a control system 152. The controller 150 includes a processor 151 and memory 153. The control system 152 is shown receiving information from sensors 154 and sending control signals to actuators 156. As one example, the sensors 154 may include sensors such as oil flowrate sensor, an oil level sensor, a gearbox speed sensor, gearbox clutch sensors, and the like. The actuators 156 may include an actuator for the fluid pump 116, actuators for the gearbox clutches, and the like. The controller 150 may receive input data from the sensors, process the input data via a processor, and trigger the actuators in response to the processed input data based on instruction or code programmed therein corresponding to one or more routines. In some examples, the controller 150 may include instructions that send a command signal to the fluid pump 116 to adjust the flowrate at the pump's output.

An axis system is provided in FIG. 1 as well as FIGS. 2-6, for reference. The z-axis may be a vertical axis (e.g., parallel to a gravitational axis), the x-axis may be a lateral axis (e.g., horizontal axis), and/or the y-axis may be a longitudinal axis, in one example. However, the axes may have other orientations, in other examples.

FIG. 2 shows an example of a fluid reservoir assembly 200. It will be appreciated that when in use, the fluid reservoir assembly 200 is incorporated into an axle assembly and fluid delivery system such as the axle assembly 106 and the fluid delivery system 114 depicted in FIG. 1. As such, the systems, assemblies, components, and the like shown in FIG. 1 may have structural and/or functional overlap with the systems, assemblies, components, and the like shown in FIG. 2 and vice versa.

The fluid reservoir assembly 200 includes a sleeve 201 that is coupled (e.g., removably coupled) to an axle tube 202. To elaborate, the sleeve 201 may be threadingly engaged with the axle tube 202. As such, the sleeve 201 may include threads on an interior surface and the axle tube 202 may include threads on an exterior surface. Additionally or alternatively, the sleeve 201 and the axle tube 202 may be press-fit.

The sleeve 201 includes an end cap 204 in the illustrated example. The end cap 204 may be positioned on one side 206 of the sleeve 201 that is opposite the side 208 of the sleeve 201 which is coupled (e.g., threaded onto) to the axle tube 202. However, the sleeve may have another suitable construction, in alternate examples. For instance, the end cap may be positioned in an alternate location or may be omitted from the sleeve in different examples.

A fluid reservoir 600, shown in FIG. 6, is formed between an inner surface 602 of the sleeve 201 and an outer surface 604 of the axle tube 202. An interior surface 606 of the end cap 204 may additional bound the fluid reservoir 600.

Continuing with FIG. 2, the fluid reservoir assembly 200 may further include a return port 210 and/or a pressure relief valve 212 which is configured to open when the pressure in the fluid reservoir 600, shown in FIG. 6, exceeds a threshold pressure (e.g., a positive non-zero value) to avoid overpressure conditions in the fluid reservoir. The pressure relief valve may be a check valve, for example. The return port 210 and/or the pressure relief valve 212 may be positioned at or near an uppermost portion of the fluid reservoir (with regard to a vertical axis when the axle is on a flat surface) to achieve desired flow dynamics in the system. It will be appreciated that the axle may articulate during vehicle travel on uneven surfaces. However, as previously indicated the axle may be a beam axle.

As illustrated in FIG. 2, a flange 214 may be coupled to or incorporated into the sleeve 201. However, in other examples, the flange may be omitted from the fluid reservoir assembly 200. Cutting plane A-A′ indicates the cross-sectional view depicted in FIG. 6.

FIG. 3 shows another view of the fluid reservoir assembly 200 with the sleeve 201 which is coupled to the axle tube 202. The sleeve 201 includes outlet ports 300 and 302. The outlet ports 300, 302 may be positioned on opposing sides 304 and 306 of the sleeve 201. Positioning the outlet ports 300, 302 in this manner allows fluid to be pulled from the fluid reservoir 600, shown in FIG. 6, as the axle articulates through its range of motion. In this way, the fluid delivery system is able to route oil from the fluid reservoir to downstream components over a wider range of conditions.

The outlet ports 300, 302 are configured to fluidly connect to a component (e.g., the fluid pump 116 shown in FIG. 1). The return port 210 and the pressure relief valve 212 are further illustrated in FIG. 3.

FIG. 4 shows another view of the fluid reservoir assembly 200 with the axle tube 202, the end cap 204 which is coupled to the sleeve. The end cap 204 is depicted with a tool interface 400 (e.g., slots for a spanner wrench or a socket, in one use-case example) for a tool 402 which allows the sleeve to be rotated about the central axis of the assembly. To elaborate, the interface is formed via openings (e.g., four openings) for a wrench, in the illustrated example. However, the interface may take a variety of forms based on the desired type of tool used for installing the sleeve. In this way, the sleeve may be efficiently installed and removed. However, other end cap configurations have been contemplated.

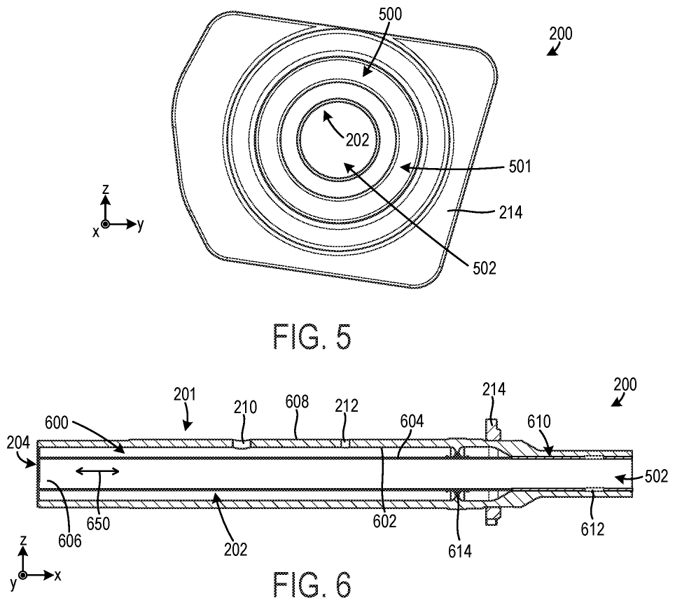

FIG. 5 shows another view of the fluid reservoir assembly with the sleeve 201, the axle tube 202, and the flange 214. In the illustrated example, the sleeve 201 includes a tapered section 500 at an end 501 which is outboard of the flange 214. The axle tube 202 includes an interior axle shaft opening 502 through which an axle shaft may be routed when installed in an axle.

FIG. 6 shows a cross-sectional view of the fluid reservoir assembly 200 with the sleeve 201, the axle tube 202, the end cap 204, the flange 214 the return port 210, the pressure relief valve 212, the axle shaft opening 502 in the axle tube, and the fluid reservoir 600. It will be understood, that the axle shaft opening 502 may be fluidly separated from the fluid reservoir 600. Consequently, churning losses with regard to the axle shaft are avoided, if desired.

An outer surface 608 of the sleeve 201, outboard of the flange 214, may have a substantially constant diameter along its length, in one example. However, in other examples, the sleeve's outer diameter may vary along its length. The shape of the sleeve may be selected based on the target volumetric capacity of the fluid reservoir, the surrounding vehicle components, axle tube profile, and the like.

FIG. 6 further shows the threaded interface 610 between the sleeve 201 and the axle tube 202. The threaded interface 610 is formed via threads on a portion of the interior surface of the sleeve 201 and threads on a portion of the exterior surface of the axle tube 202. Additionally or alternatively, a press-fit interface 612 may be formed between the sleeve 201 and the axle tube 202. A rotational axis 650 of the axle shaft that is routed through the axle tube is further illustrated in FIG. 6. The fluid reservoir assembly 200 may further include a seal 614 which is formed in the sleeve 201 and reduces the likelihood of fluid undesirably exiting the fluid reservoir 600 through the threaded interface 610. However, the seal may be omitted from the fluid reservoir assembly 200 or the reservoir assembly may include additional seals, in different examples.

The descriptions of FIGS. 1-6 provide for a method for operation of a fluid delivery system where fluid (e.g., oil) is drawn from a fluid reservoir in a fluid reservoir assembly that is incorporated into an axle assembly with an axle tube to a fluid pump and delivering the fluid from the pump to downstream components such as lubricated components and/or hydraulic actuators which may be included in a gearbox. The method may further include flowing fluid from the gearbox back to the fluid reservoir via the return port.

The technical effect of the methods for operation of the fluid delivery system described herein is to efficiently deliver a fluid such as oil to targeted components from a space efficient fluid reservoir that is incorporated in an axle assembly.

FIGS. 2-6 are drawn approximately to scale, aside from the schematically depicted components. However, alternate relative component dimensions may be used in other embodiments.

FIGS. 1-7 show example configurations with relative positioning of the various components. It will be appreciated that if elements are shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Additionally, elements co-axial with one another may be referred to as such, in one example. Further, elements shown intersecting one another may be referred to as intersecting elements or intersecting one another, in at least one example. Further still, an element shown within another element or shown outside of another element may be referred as such, in one example. In other examples, elements offset from one another may be referred to as such. Still further in some examples, elements positioned coaxial or parallel to one another may be referred to as such.

The invention will be further described in the following paragraphs. In one aspect, a fluid reservoir assembly is provided that comprises an axle tube circumferentially surrounding an axle shaft in an axle; a sleeve coupled to the axle tube; and a fluid reservoir containing a working fluid and formed in a cavity between an exterior surface of the axle tube and an interior surface of the sleeve; wherein the fluid reservoir is configured to fluidically connect to a component.

In another aspect, a method for operation of a fluid delivery system is provided that comprises drawing a working fluid from a fluid reservoir assembly to a fluid pump; wherein the fluid reservoir assembly includes: an axle tube circumferentially surrounding an axle shaft in a beam axle; a sleeve removably coupled to the axle tube; and a fluid reservoir containing a working fluid and formed in a cavity between an exterior surface of the axle tube and an interior surface of the sleeve; wherein the fluid reservoir is configured to fluidically connect to a component. The method may further comprise, in one example, delivering the working fluid to a lubricated component from the fluid pump. Still further in one example, the method may further include delivering the working fluid to a hydraulic actuator from the fluid pump.

In yet another aspect, an oil reservoir assembly is provided that comprises an axle tube circumferentially surrounding an axle shaft in a beam axle; a sleeve removably coupled to the axle tube; and an oil reservoir containing oil and formed in a cavity between an exterior surface of the axle tube and an interior surface of the sleeve; wherein the sleeve includes a first outlet port in fluidic communication with an oil pump.

In any of the aspects or combinations of the aspects, the sleeve may be coupled to the axle tube via a threaded interface.

In any of the aspects or combinations of the aspects, the sleeve may include an end cap which is incorporated into an opposite side of the sleeve as the threaded interface.

In any of the aspects or combinations of the aspects, the end cap may include a tool interface.

In any of the aspects or combinations of the aspects, the fluid reservoir may be a dry sump.

In any of the aspects or combinations of the aspects, the fluid reservoir assembly may further comprise a first outlet port and a second outlet port in fluidic communication with a fluid pump and positioned on opposing lateral sides of the sleeve.

In any of the aspects or combinations of the aspects, the fluid reservoir assembly may further comprise a pressure relief valve incorporated in the sleeve.

In any of the aspects or combinations of the aspects, the fluid reservoir assembly may further comprise a return port incorporated in the sleeve.

In any of the aspects or combinations of the aspects, the component may be a lubricated component.

In any of the aspects or combinations of the aspects, the component may be a hydraulic reservoir.

In any of the aspects or combinations of the aspects, the sleeve may be coupled to the axle tube via a press-fit interface.

In any of the aspects or combinations of the aspects, the reservoir assembly may further include a second outlet port in fluidic communication with the oil pump, wherein the first and second outlet ports are positioned on opposing sides of the sleeve.

In any of the aspects or combinations of the aspects, the sleeve may have an end cap incorporated therein and configured to be rotated via a tool.

In any of the aspects or combinations of the aspects, the first outlet portion may be positioned at the lowest point of the oil reservoir.

In any of the aspects or combinations of the aspects, the assembly may further comprise a return port and a pressure relieve valve incorporated into the sleeve, wherein the return port is in fluidic communication with a gearbox.

Note that the example control and estimation routines included herein can be used with various powertrain, gearbox, and/or vehicle system configurations. The control methods and routines disclosed herein may be stored as executable instructions in non-transitory memory and may be carried out by the control system including the controller in combination with the various sensors, actuators, and other vehicle hardware. Further, the described actions, operations and/or functions may graphically represent code to be programmed into non-transitory memory of the computer readable storage medium in the vehicle control, where the described actions are carried out by executing the instructions in a system including the various hardware components in combination with the electronic controller. One or more of the method steps described herein may be omitted if desired.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive. As such, these specific examples are not to be considered in a limiting sense, because numerous variations are possible. For example, the above technology can be applied to powertrains that include different types of propulsion sources including different types of electric machines and engines (e.g., internal combustion engines). The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A fluid reservoir assembly, comprising:
an axle tube circumferentially surrounding an axle shaft in an axle;
a sleeve coupled to the axle tube; and
a fluid reservoir containing a working fluid and formed in a cavity between an exterior surface of the axle tube and an interior surface of the sleeve;
wherein the fluid reservoir is configured to fluidically connect to a component.

2. The fluid reservoir assembly of claim 1, wherein the sleeve is coupled to the axle tube via a threaded interface.

3. The fluid reservoir assembly of claim 2, wherein the sleeve includes an end cap which is incorporated into an opposite side of the sleeve as the threaded interface.

4. The fluid reservoir assembly of claim 3, wherein the end cap includes a tool interface.

5. The fluid reservoir assembly of claim 1, wherein the fluid reservoir is a dry sump.

6. The fluid reservoir assembly of claim 1, further comprising a first outlet port and a second outlet port in fluidic communication with a fluid pump and positioned on opposing lateral sides of the sleeve.

7. The fluid reservoir assembly of claim 1, further comprising a pressure relief valve incorporated in the sleeve.

8. The fluid reservoir assembly of claim 1, further comprising a return port incorporated in the sleeve.

9. The fluid reservoir assembly of claim 1, wherein the component is a lubricated component.

10. The fluid reservoir assembly of claim 1, wherein the component is a hydraulic reservoir.

11. The fluid reservoir assembly of claim 1, wherein the sleeve is coupled to the axle tube via a press-fit interface.

12. A method for operation of a fluid delivery system, comprising:
drawing a working fluid from a fluid reservoir assembly to a fluid pump;
wherein the fluid reservoir assembly includes:
an axle tube circumferentially surrounding an axle shaft in a beam axle;
a sleeve removably coupled to the axle tube; and
a fluid reservoir containing the working fluid and formed in a cavity between an exterior surface of the axle tube and an interior surface of the sleeve; and
wherein the fluid reservoir is configured to fluidically connect to a component.

13. The method of claim 12, further comprising delivering the working fluid to a lubricated component from the fluid pump.

14. The method of claim 12, further comprising delivering the working fluid to a hydraulic actuator from the fluid pump.

15. The method of claim 12, wherein the working fluid is oil and the component is a lubricated component or a hydraulic actuator.

16. The method of claim 15, wherein the lubricated component and the hydraulic actuator are included in a gearbox.

17. An oil reservoir assembly comprising:
an axle tube circumferentially surrounding an axle shaft in a beam axle;
a sleeve removably coupled to the axle tube; and
an oil reservoir containing oil and formed in a cavity between an exterior surface of the axle tube and an interior surface of the sleeve;
wherein the sleeve includes a first outlet port in fluidic communication with an oil pump.

18. The oil reservoir assembly of claim 17, further comprising a second outlet port in fluidic communication with the oil pump, wherein the first and second outlet ports are positioned on opposing sides of the sleeve.

19. The oil reservoir assembly of claim 17, wherein the sleeve has an end cap that is incorporated therein and configured to be rotated via a tool.

20. The oil reservoir assembly of claim 17, further comprising a return port and a pressure relieve valve incorporated into the sleeve, wherein the return port is in fluidic communication with a gearbox.
